(19) United States
(12) Patent Application Publication
(10) Pub. No.: US 2009/0035078 A1
(43) Pub. Date: Feb. 5, 2009

(54) Fixation Device for Fixating a Portable Orbital Drilling Machine to a Drilling Template

(75) Inventors: Stefan Mejerwall, Upplands Vasby (SE); Bjorn Pettersson, Jarfalla (SE)

Correspondence Address: SCHWEGMAN, LUNDBERG & WOESSNER, P.A., P.O. BOX 2938, MINNEAPOLIS, MN, 55402, US

(73) Assignee: Novator ABStormbyvagen 6Spanga,

(21) Appl. No.: 11/794,138

(22) PCT Filed: Jan. 20, 2006
(86) PCT No.: PCT/SE06/00083

§ 371 Date: Mar. 17, 2008

Related U.S. Application Data
(60) Provisional application No. 60/593,808, filed on Feb. 16, 2005.

(51) Int. Cl. B23B 39/00

(52) U.S. Cl. 408/87

(57) ABSTRACT

A fixation device (10) for fixating a portable orbital drilling machine to a drilling template (20), comprising a housing assembly (12, 50, 54, 56, 58) configured to be detachably secured to the drilling machine; distal locking members (16) projecting from a housing body (12) of said assembly and configured to receive corresponding locating pins (18) fixated to the template (20) at a distance from a template hole (22). The fastening device (10) comprises three locking members (16), each having a respective pin-receiving key-hole opening (32) for receiving a respective locating pin (18) and disposed at a respective apex of an imaginary equilateral triangle; a draw member (38) having three axially projecting feet (40) and provided with a respective key-hole opening (42) corresponding to the pin-receiving opening (32) of the locking member (16); and a slidable piston (44, 46) acting together with the draw member (38) to control the axial movement thereof in order to fixedly clamp and release the fastening device (10) to the drilling template (20).

### BACKGROUND OF THE INVENTION

1. Field of the Invention

The present invention relates to a fixation device for fixating a portable orbital drilling machine to a drilling template. The fixation device comprises a housing assembly configured to be detachably secured to the drilling machine; distal locking members projecting from a housing body of said assembly and configured to receive corresponding locating pins fixated to the template at a distance from a template hole, said locking members having a respective pin-receiving opening configured to receive a head and a stud of a respective locating pin.

2. Description of the Related Art

WO 02/102535 (U.S. Pat. No. 6,902,361) discloses a fixation device of the closest prior art. Two locating pins are attached to and project from the template proximate and diametrically opposed to each hole therein, and the fixation device comprises a clamping mechanism mounted to a housing for coupling a housing template end with each of said two locating pins. The clamping mechanism includes a piston located within the housing, a clamping actuator, an unclamping actuator, and two ball holders attached to the distal end of the housing. Each ball holder is configured to concentrically circumscribe a respective one of the two locating pins. Two pressure cylinders are disposed on a distal end of the piston. A plurality of releasable balls are located in each ball holder, and each locating pin includes an annular groove in which the balls engage during actuation of said clamping actuator and disengage during actuation of said unclamping actuator. The twin ball holder arrangement of the clamping is rather complex and expensive, and the stability of the fixation of the drilling machine is, in some instances, not sufficient for high precision demands. Furthermore, this fixation device requires a relatively long axial stroke of the piston for controlling the locking and unlocking state of the fixation device.

### SUMMARY OF THE INVENTION

An object of the present invention is to provide a fixation device of the kind mentioned by way of introduction having a simplified structure and which has improved properties as to the ability of taking up forces generated during a hole-making process and better stability when fixated to the locating pins on the template.

Another object of the invention is to provide a fixation device which allows the axial stroke of the piston for controlling the axial movement of the draw member, and thus the locking and unlocking state of the fixation device, to be relatively short.

For this purpose the fixation device of the invention comprises three locking members, each disposed at a respective apex of an imaginary equilateral triangle; an annular draw member having three axially extending feet received in the locking members and provided with a respective key-hole opening corresponding to the pin-receiving opening of the locking member, said key-hole opening having a hole for receiving the head of the pin, and a circumferentially directed slot adjoining the head-receiving hole; and a piston slidable axially within a chamber of said housing body and acting together with the draw member to control the axial movement thereof in order to fixedly clamp the fixation device to the drilling template by engaging the pins underneath the heads thereof when axially displacing the draw member away from the template and to release the fixation device when displacing the draw member towards the template.

Further features and advantages of the fixation device of the present invention will be apparent from the detailed description and the appended dependent claims with reference to the accompanying drawings.

### BRIEF DESCRIPTION OF THE DRAWINGS

FIG. 1 is a side elevational view of a fixation device of the invention;

FIG. 2 is an axial cross-sectional view of the fixation device of the present invention, taken along the section line II-II in FIG. 1;

FIG. 3 is plan view from below of the fixation device in FIG. 1;

FIG. 4 is a perspective view from below of the fixation device in FIG. 1;

FIG. 5 is an exploded perspective view from above of components of the fixation device; and

FIG. 6 is a cross-sectional view of the fixation device attached to a template.

### DESCRIPTION OF PREFERRED EMBODIMENT OF THE INVENTION

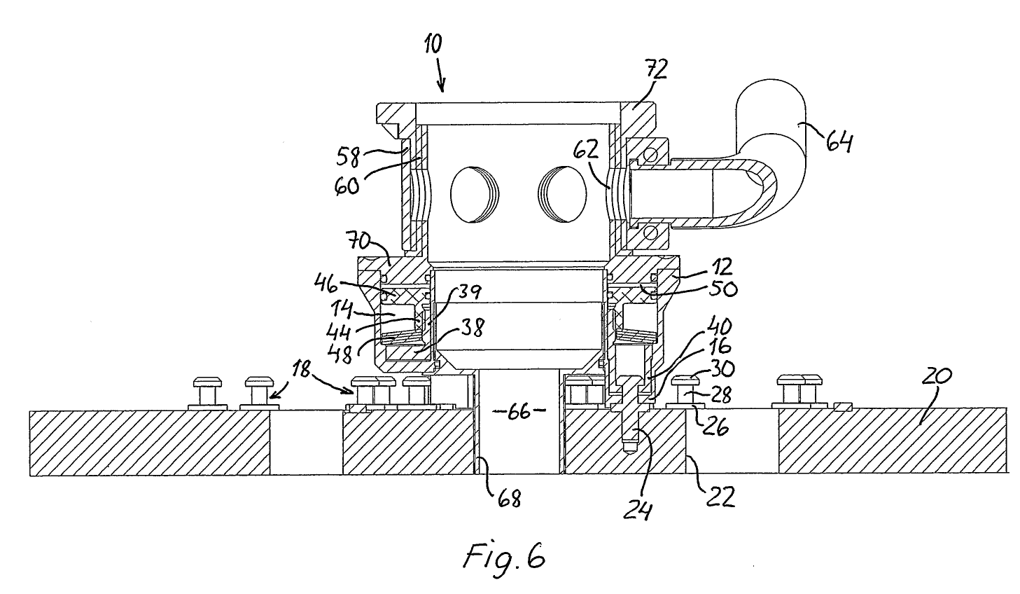

In FIGS. 1, 2 and 6, 10 generally denotes a fixation device of the present invention. It includes, i.a., a lower sleeve-like housing body 12 with an annular chamber 14. The housing 12 has three downwardly projecting, hollow locking members 16 located at a respective apex of an imaginary equilateral triangle corresponding to location of three locating pins 18 (FIG. 6) attached to a drilling template 20 at a radial distance to the center of a guide hole 22 in the template 20.

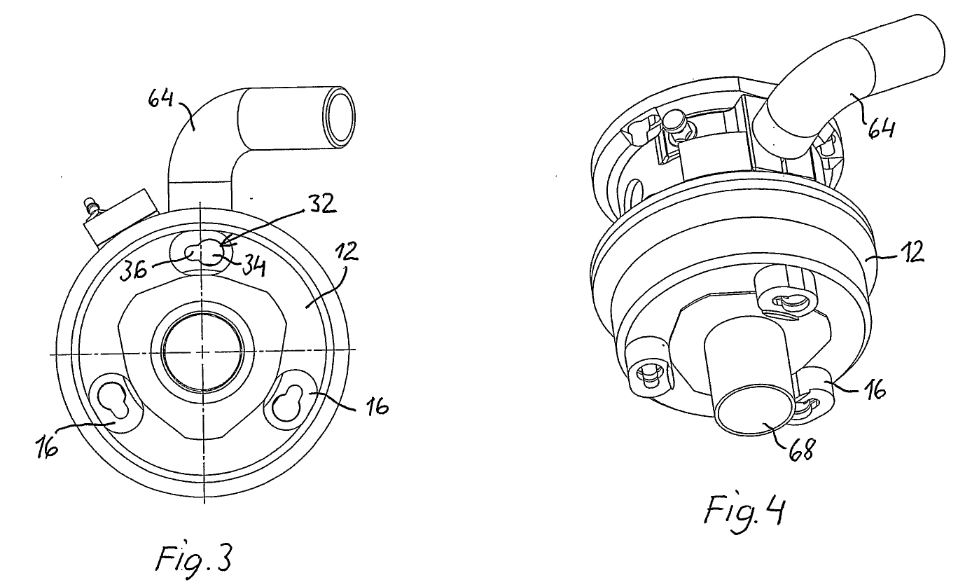

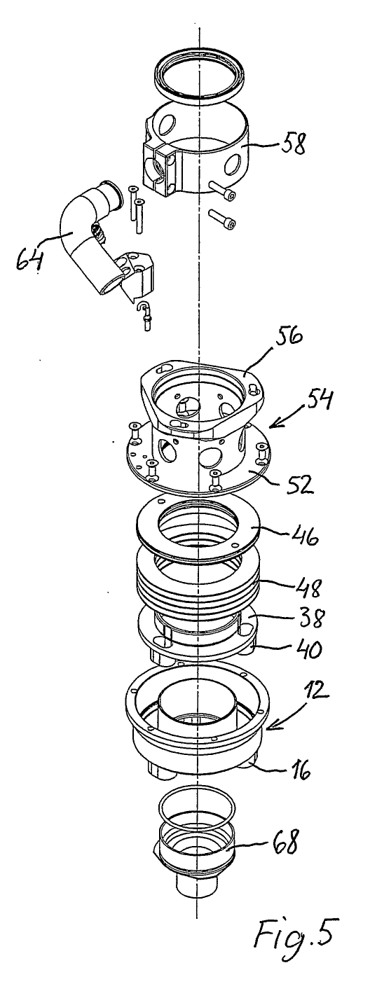

As seen in FIG. 6, the locating pins 18 have a threaded shaft 24 fixated in a threaded hole in the template 20, a radial foot 26 resting in a recess in the template 20, and a stud 28 with an enlarged head or top 30. As best seen in FIG. 3, the locking members 16 have a pin-receiving opening with the shape of a key hole 32, i.e. a circular hole 34 for receiving the head 30 of the stud 28, and a short tangential or circumferentially directed slot 36 adjoining the circular hole 34 and configured to freely receive the stud 28 of the locating pin 18 when rotating the housing body 12 and the entire drilling machine attached thereto about 10° relative to the fixated locating pins 18.

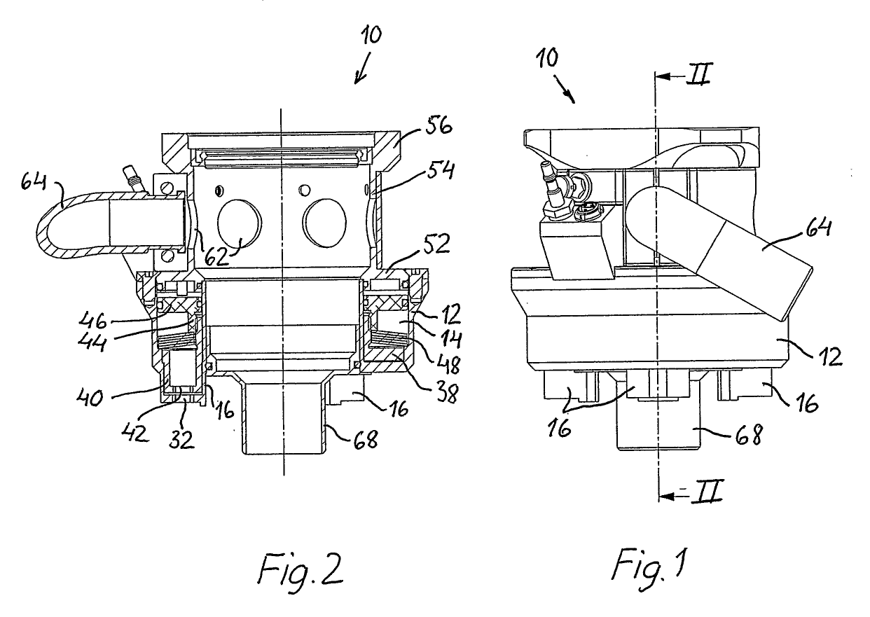

An annular draw or pull member 38 having three downwardly projecting feet 40 corresponding to the locking members 16 and with similar key holes 42 with short tangential slots at the lower end of the feet 40 for receiving the respective studs 28, when rotating of the housing body 12 relative to the locating pins 18, is axially movable in the chamber 14 in the housing 12 while the feet 40 are slidable in the three hollow portions of the locking member 16. The draw member 38 is configured to press the locking members 16 and thus the housing 12 against the foot 26 of the pins 18 by engaging the pins 18 underneath the heads 30 thereof when axially displacing the draw member 38 away from the template 20. An upper hub portion 39 of the draw member 38 is attached by threads to a lower hub portion 44 of an annular piston head 46 slidable in the chamber 14 of the housing body 12. The piston 44, 46 is biased towards an upper, pin-locking position by means of a set of Belleville washers 48 acting on the hub portion 44 of the piston head 46. As shown in FIGS. 2 and 6, the piston 44, 46 may be pushed downwardly against the action of the Bellville washers 48 to a pin-unlocking position by supplying compressed air to a space 50 above the upper surface of the piston 46.

As shown in FIGS. 2 and 5, the chamber 14 of the housing body 12 is covered by an annular lower flange 52 of a sleeve 54 which is integrated with an upper socket 56 for coupling the fixation device 10 to a portable orbital drilling machine (not shown) by means of a tensioning ring 58. The sleeve 54 and the socket 56 have coinciding apertures 62 connected to a chips extracting tube 64 and to a central shaft 66 communicating with the inner space of an exchangeable cutting tool protective tube 68. Alternately, as shown in FIG. 6, the sleeve may be formed in two parts, i.e. a chamber lid part 70 and a socket part 72, interconnected by the tensioning ring 58 with an intermediate electrically insulating sleeve 60.

In order to secure the fixation device 10, and thus a portable orbital drilling machine attached thereto, to a drilling template 20, the three locking members 16 of the housing body 12 are threaded over the heads 30 of the three associated locating pins 18 so that the pin heads 30 fully penetrates the coinciding circular holes 34 of the key holes 32, 42 in the locking members 16 and the feet 40 of the draw member 38. Then, the drilling machine and the fixation device 10 attached thereto is rotated approximately 10° so that the studs 28 of the locating pins 18 are fully received in the circumferential slots 36 of the key holes 32, 42. During these two initial steps of securing the drilling machine to the template 20 compressed air is supplied to the chamber 50 above the upper surface of the piston head 46 so as to hold down the draw member 38 while compressing the Belleville washers 48 to allow the pin heads 30 to fully pass through the key holes. Then, the air pressure is released from the chamber 50 to let the washers 48 raise the piston 44, 46 and the draw member 38 so that the feet 40 of the latter will engage the pin heads 30 from underneath and thus securely fixate the drilling machine to the template by a clamping action.

Although the described and illustrated most preferred embodiment explicitly includes three locking members 16, each disposed at a respective apex of an imaginary equilateral triangle, it should be noted that it would be possible to increase the number of locking members without leaving the concept of the present invention. Furthermore, it would also be possible within the scope of the present invention to spring-bias the piston towards a pin-unlocking position and to use pressurized air to hold the fixation device in a locked position.

1. A fixation device for fixating a portable orbital drilling machine to a drilling template, comprising:
a housing assembly configured to be detachably secured to the drilling machine, the housing assembly including a housing body; and
distal locking members projecting from the housing body of said assembly and configured to receive corresponding locating pins fixated to the template at a distance from a template hole, said locking members having a respective pin-receiving opening configured to receive a head and a stud of a respective locating pin, characterized in that the fixation device comprises three locking members, each disposed at a respective apex of an imaginary equilateral triangle; an annular draw member having three axially extending feet received in the locking members and provided with a respective key-hole opening corresponding to the pin-receiving opening of the locking member, said key-hole opening having a hole for receiving the head of the pin, and a circumferentially directed slot adjoining the head-receiving hole; and a piston axially slidable within a chamber of said housing body and acting together with the draw member to control the axial movement thereof in order to fixedly clamp the fixation device to the drilling template by engaging the pins underneath the heads thereof when axially displacing the draw member away from the template and to release the fixation device when displacing the draw member towards the template.

2. The fixation device of claim 1, wherein the assembly including the piston and the draw member is biased towards a pin-locking position by a spring unit.

3. The fixation device of claim 2, wherein the spring unit a set of Belleville washers acting on the piston.

4. The fixation device of claim 3, wherein the assembly including the piston and the draw member is displaceable towards a pin-unlocking position against the action of the spring unit by supplying compressed air to a space on one side of a head of the piston.

5. The fixation device of claim 2, wherein the assembly including the piston and the draw member is displaceable towards a pin-unlocking position against the action of the spring unit by supplying compressed air to a space on one side of a head of the piston.

6. The fixation device of claim 1, further comprising a compressed air supply to displace the assembly including the piston and the draw member toward a pin-unlocking position by supplying compressed air to a side of a head of the piston.

7. The fixation device of claim 1, wherein the pin-receiving openings of the locking members allow for about 10 degree of rotation of the housing body on the locating pins.

8. A fixation device for fixating a portable orbital drilling machine to a drilling template with a plurality of locating pins at a distance from a template hole, the fixation device comprising:
a housing assembly to be detachably secured to the drilling machine, the housing assembly including a housing body, the housing body including a chamber;
at least three distal locking members projecting from housing body, the plurality of distal locking members being configured to receive the locating pins, the locking members having a respective pin-receiving opening to receive a head and a stud of a respective locating pin, the locking members being equidistant from each other;
an annular draw member having at least three axially extending feet respectively received in the locking members and provided with a respective key-hole opening corresponding to the pin-receiving opening of the locking member;
wherein the key-hole opening has a hole for receiving the head of the pin and a circumferentially directed slot adjoining the head-receiving hole; and
a piston axially slidable within the chamber of the housing body and acting together with the draw member to control the axial movement thereof in order to fixedly clamp the fixation device to the drilling template by engaging the pins underneath the heads thereof when axially displacing the draw member away from the template and to release the fixation device when displacing the draw member towards the template.

9. The fixation device of claim 8, wherein the housing assembly includes a biasing unit to bias at least the piston and the draw member to a pin-locking position.

10. The fixation device of claim 9, wherein the biasing unit includes a set of Belleville washers acting on the piston.

11. The fixation device of claim 10, wherein the housing assembly include a compressed air source to act against the force of the biasing unit to displace the piston and the draw member towards a pin-unlocking position.

12. The fixation device of claim 11, wherein the housing assembly includes a space on one side of a head of the piston, the space to receive compressed air to displace the piston and the draw member towards a pin-unlocking position.

13. The fixation device of claim 12, wherein the pin-receiving openings of the locking members allow for about 10 degree of rotation of the housing body on the locating pins.

14. The fixation device of claim 9, wherein the housing assembly include a compressed air source to act against the force of the biasing unit to displace the piston and the draw member towards a pin-unlocking position.

15. The fixation device of claim 14, wherein the housing assembly includes a space on one side of a head of the piston, the space to receive compressed air to displace the piston and the draw member towards a pin-unlocking position.

16. The fixation device of claim 8, further comprising a compressed air supply to displace the assembly including the piston and the draw member toward a pin-unlocking position by supplying compressed air to a side of a head of the piston.

17. The fixation device of claim 8, wherein the pin-receiving openings of the locking members allow for about 10 degree of rotation of the housing body on the locating pins.
